(19) United States
(12) Patent Application Publication
(10) Pub. No.: US 2012/0259685 A1
(43) Pub. Date: Oct. 11, 2012

(54) Systems and Methods for Managing Pre-Paid Transactions

(76) Inventors: Alec Brent Gardner, Dallas, TX (US); Daniel Alexander Jardin, Dallas, TX (US)

(21) Appl. No.: 13/082,878

(22) Filed: Apr. 8, 2011

(51) Int. Cl. G06Q 30/00

(52) U.S. Cl. 705/14.17

(57) ABSTRACT

Systems and methods for managing pre-paid transactions are provided. In one embodiment, a method for managing pre-paid transactions includes receiving a set of vendor settings from a first vendor in a plurality of vendors. The set of vendor settings includes an offer associated with a bonus definable by the first vendor. The method also includes receiving a deposit of funds for the first vendor from a consumer, determining whether the consumer qualifies for the offer from the first vendor, and crediting a consumer account associated with the consumer with the deposit of funds and the bonus in response to determining that the consumer qualifies for the offer from the first vendor. The deposit of funds and the bonus is spendable at the first vendor using a consumer card associated with the consumer account.

### TECHNICAL FIELD

The illustrative embodiments relate generally to managing transactions, and more particularly, to managing pre-paid transactions between consumers and vendors.

### BACKGROUND

The emergence of computer technology has fostered the proliferation, of methods by which to conduct commercial transactions. For example, transactions using credit cards, debit cards, gift cards, and other current methods are often implemented with the assistance of computer technology. Pre-paid gift cards and debit cards have also become available to consumers, but often fail to effectively leverage or utilize the prepayment of funds or computer technology to benefit consumers or vendors. For example, current pre-paid methods of conducting transactions may fail to provide consumers and vendors with adequate cost savings, flexibility, and/or useful analytical data. These pre-paid methods may also fail to provide a convenient and easy-to-use computer-implemented medium through which commercial transactions may be conducted between consumers and vendors. Moreover, current pre-paid methods may fail to move funds, such as deposited funds, directly to vendors or fail to provide a central method of payment, such as a universal card, usable at multiple different vendors. Current pre-paid methods may also fail to reward consumers with concessions from vendors in light of the time-value of money and the benefits of receiving consumer funds prior to loss of inventory, and therefore fail to appreciate the economic effect of pre-payment.

### SUMMARY

According to an illustrative embodiment, a method for managing pre-paid transactions includes receiving a set of vendor settings from a first vendor in a plurality of vendors. The set of vendor settings includes an offer associated with a bonus definable by the first vendor. The method also includes receiving a deposit of funds for the first vendor from a consumer, determining whether the consumer qualifies for the offer from the first vendor, and crediting a consumer account associated with the consumer with the deposit of funds and the bonus in response to determining that the consumer qualifies for the offer from the first vendor. The deposit of funds and the bonus is spendable at the first vendor using a consumer card associated with the consumer account.

According to another illustrative embodiment, a method for managing pre-paid transactions includes receiving one or more offers from a plurality of vendors. Each of the offers is associated with a minimum deposit amount and a respective bonus. The one or more offers includes a first offer from a first vendor in the plurality of vendors. The first offer is associated with a first bonus. The method also includes receiving a consumer selection of the first vendor in the plurality of vendors, receiving a deposit of funds for the first vendor from a consumer, determining whether the deposit of funds meets or exceeds the minimum deposit amount for the first offer from the first vendor, and crediting a vendor account balance, associated with the first vendor, in a consumer account with at least one of the deposit of funds or the first bonus in response to determining that the deposit of funds meets or exceeds the minimum deposit amount for the first offer from the first vendor. The deposit of funds and the first bonus is spendable at the first vendor.

According to another illustrative embodiment, a pre-paid transaction manager includes a vendor module that includes a plurality of vendor accounts for a plurality of vendors. Each of the plurality of vendors has at least one of the plurality of vendor accounts. The vendor module receives a plurality of offers from the plurality of vendors. Each of the plurality of offers is associated with respective offer settings. The pre-paid transaction manager also includes a consumer module that includes a plurality of consumer accounts for a plurality of consumers. The consumer module presents one or more offers from a first vendor in the plurality of vendors to a consumer when the consumer selects the first vendor. The pre-paid transaction manager also includes an offer qualification engine to determine whether a deposit of funds received from the consumer qualifies the consumer for an offer from the first vendor using the respective offer settings of the offer. The pre-paid transaction manager may credit a consumer account for the consumer with the deposit of funds and a bonus associated with the offer if the offer qualification engine determines that the deposit of funds received from the consumer qualifies the consumer for the offer from the first vendor.

### BRIEF DESCRIPTION OF THE DRAWINGS

FIG. 1 is a schematic, pictorial representation of a pre-paid transaction according to an illustrative embodiment;

FIG. 2 is a schematic diagram showing an interaction between elements in FIG. 1 according to an illustrative embodiment;

FIG. 3 is a schematic, block diagram of a pre-paid transaction system according to an illustrative embodiment;

FIG. 4 is a schematic, pictorial representation of a vendor administration page usable by a vendor in the pre-paid transaction manager according to an illustrative embodiment;

FIG. 5 is a schematic, pictorial, representation of a graphical consumer interface including, inter alia, a vendor page according to an illustrative embodiment;

FIG. 6 is a flowchart of a process for managing pre-paid transactions according to an illustrative embodiment;

FIG. 7 is a flowchart of a process for managing the addition of one or more offers from a vendor in the pre-paid transaction manager according to an illustrative embodiment;

FIG. 8 is a flowchart of a process for managing pre-paid transactions according to an illustrative embodiment; and

FIG. 9 is a schematic, block diagram of a data processing system in which the illustrative embodiments may be implemented.

### DETAILED DESCRIPTION

In the following detailed description of the illustrative embodiments, reference is made to the accompanying drawings that form a part hereof. These embodiments are described in sufficient detail to enable those skilled in the art to practice the invention, and it is understood that other embodiments may be utilized and that logical structural, mechanical, electrical, and chemical changes may be made without departing from the spirit or scope of the invention. To avoid detail not necessary to enable those skilled in the art to practice the embodiments described herein, the description may omit certain information known to those skilled in the art. The following detailed description is, therefore, not to be taken in limiting sense, and the scope of the illustrative embodiments are defined only by the appended claims.

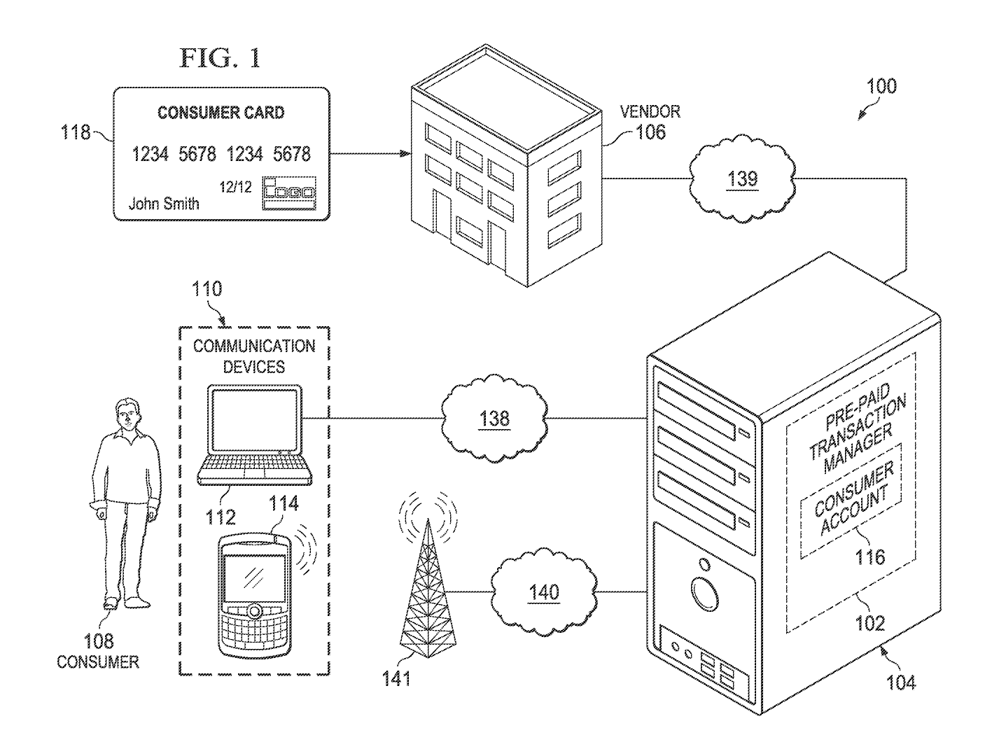

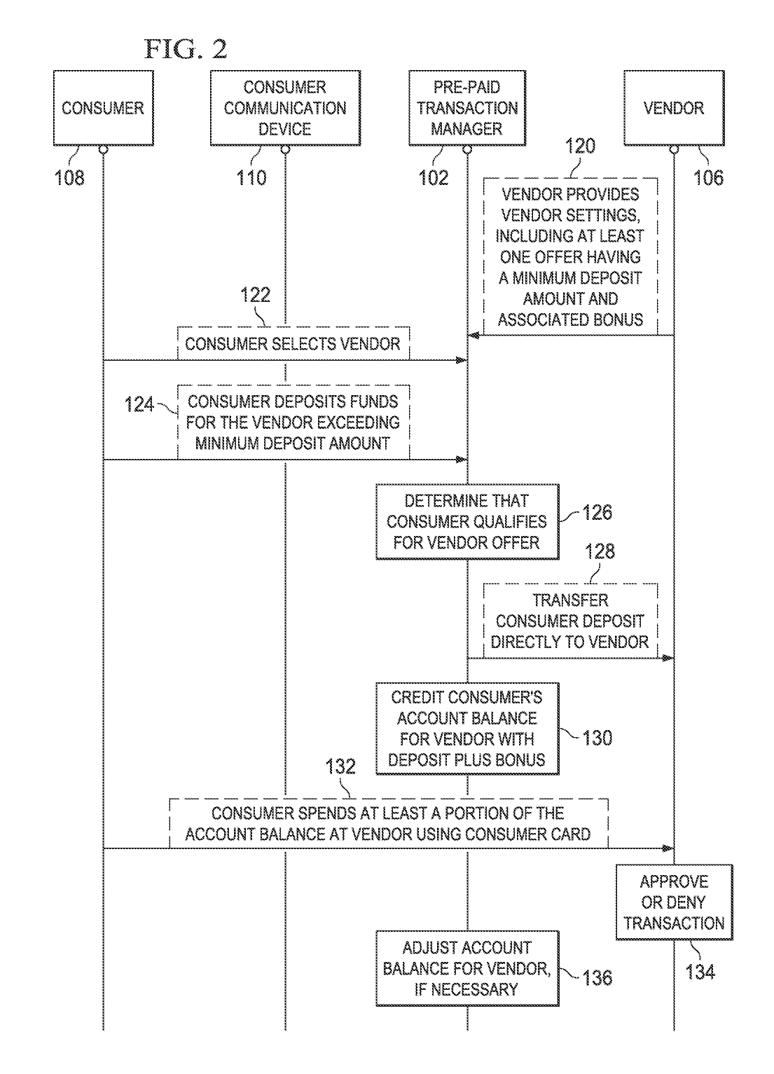

Referring to FIGS. 1 and 2, an illustrative embodiment of a pre-paid transaction system 100 includes a pre-paid transaction manager 102, implementable on one or more servers 104, which facilitates transactions between one or more vendors 106 and one or more consumers 108. The vendor 106 may be any seller or goods or services, or otherwise any entity capable of participating in a commercial transaction. Unless otherwise indicated, as used herein, “or” does not require mutual exclusivity.

The vendor 106 may make one or more offers to the consumer 108 using the pre-paid transaction manager 102. Each of these offers may include offer settings, definable by the vendor 106, that include criteria for determining whether the consumer 108 qualifies for the offer. While numerous different types of offer settings may be defined by the vendor 106, as described below, non-limiting examples of offer settings include a minimum deposit amount and/or a maximum deposit amount.

The offer settings associated with each offer from the vendor 106 may also define a bonus, such as a percentage or monetary amount, which may be credited to the consumer 108 if the consumer 108 qualifies for the offer. Like the other offer settings associated with an offer, the bonus may be defined by the vendor 106.

Using any type of communication device 110, such as a laptop 112 or a cellular phone 114, the consumer 108 may access the pre-paid transaction manager 102 over a data communication medium, such as the Internet, to select one of the vendors 106 making an offer the pre-paid transaction manager 102. In one embodiment, the consumer 108 may deposit funds, spendable at the vendor 106, into his or her consumer account 116. The consumer account 116 may be further sub-divided into one or more vendor account balances, each of which contains a balance usable towards a particular vendor, such as the vendor 106. Upon receiving the funds from the consumer 108, in one embodiment the pre-paid transaction manager 102 transfers the deposited funds directly to the vendor 106 so that the vendor 106 receives the deposited funds before the respective vendor account balance in the consumer account 116 is used to make purchases at the vendor 106.

In one embodiment, upon receiving the deposited funds from the consumer 108, the pre-paid transaction manager 102 may determine whether the consumer 108 qualifies for an offer from the vendor 106. The criteria by which the pre-paid transaction manager 102 determines whether the consumer 108 qualifies for an offer from the vendor 106 may depend on a number of factors, such as the offer settings (e.g., minimum deposit amount, maximum deposit amount, etc.) and/or the timing or amount of the deposit of funds received from the consumer 108. If the pre-paid transaction manager 102 determines that the consumer 108 qualifies for an offer from the vendor 106, the pre-paid transaction manager 102 may credit the consumer account 116 for the consumer 108 with the bonus associated with the offer for which the consumer 108 qualifies in addition to the deposit of funds received from the consumer 108.

The consumer 108 may use his or her vendor account balance in the consumer account 116 towards purchases at the vendor 106. In one embodiment, the pre-paid transaction manager 102 may associate the consumer account 116 with a consumer card 118. Using the consumer card 118, the consumer 108 may make purchases at vendors 106 using respective vendor account balances in the consumer account 116, including any bonuses in the respective vendor account balances earned by virtue of qualifying for one or more offers from the vendor 106. The consumer card 118 may be used to make purchases at the vendor 106 via, e.g., an online transaction, purchases at the physical location of the vendor 106, etc.

The consumer card 118 may be linked to the consumer account 116 such that the consumer card 118 may be used at any vendor for which the consumer 108 has a positive balance in his or her consumer account 116. For example, if the consumer 108 has deposited funds for three different types of vendors (e.g., a grocery store, a sporting goods store, and a coffee shop), the consumer 108 may use the consumer card 118 at any of these three vendors to spend the respective vendor account balances in the consumer account 116 for each of the three vendors. In one embodiment, the consumer card 118 may be usable at the vendor 106 in an analogous manner as a debit or credit card, such as by swiping a magnetic strip, entering an account or card number, touchless detection, etc., or using another process of approving a transaction and/or accounting for the corresponding adjustment of the balance.

It will be appreciated that, while FIG. 1 illustrates a single consumer 108 and a single vendor 106, the pre-paid transaction system 100 may include any number of vendors and any number of consumers (e.g., dozens, hundreds, thousands, millions, etc.). In one embodiment, by providing a unified consumer account 116 and/or consumer card 118 for each consumer 108 through which pre-paid deposits may be made and monetary bonuses may be awarded, a more convenient, scalable, and cost-saving transactional system may be provided to the consumer 108.

The communication devices usable by the consumer 108 (e.g., communication devices 110) and/or the vendor 106 to communicate with the pre-paid transaction manager 102 may be any device capable of sending or receiving data. For example, the communication devices 110 may include a computer (e.g., a laptop, netbook, tablet computer, desktop computer, or minicomputer), a cellular phone (e.g., a smart phone), a personal digital assistant, a kiosk, a portable gaming device, a web browsing device, a media player, etc.

Referring specifically to FIG. 2, a non-limiting example of a transaction using the pre-paid transaction manager 102 is illustrated using the components of the pre-paid transaction system 100. The vendor 106 may provide vendor settings, or specifications, to the pre-paid transaction manager 102 (data communication 120). The vendor settings may include at least one offer having offer settings that include a minimum deposit amount and an associated bonus. The consumer 108 may select the vendor 106 using an interface for the pre-paid transaction manager displayed on the consumer communication device 110 (data communication 122). The consumer 108 may then deposit funds usable towards the vendor 106, and this deposit of funds may meet and/or exceed the minimum deposit amount indicated by the offer settings of the offer made by the vendor 106 (data communication 124).

The pre-paid transaction manager 102 may determine that the consumer 108 qualifies for the vendor's offer (process 126). In one embodiment, the pre-paid transaction manager 102 may determine that the consumer 108 qualifies for the offer by determining that the deposit of funds from the consumer 108 meets or exceeds the minimum deposit amount associated with the offer. For example, if the offer from the vendor 106 has a minimum deposit amount of $100, the pre-paid transaction manager 102 may determine that the consumer 108 qualifies for the offer if the deposit of funds from the consumer 108 meets or exceeds $100. As described below, other offer settings may also be associated with the offer from the vendor 106, and these offer settings may be used as criteria to determine whether the consumer 108 qualifies for the offer.

In one embodiment, upon or after receiving the deposit of funds from the consumer 108, the pre-paid transaction manager 102 may transfer the deposit of funds from the consumer 108 directly to the vender 106 (data communication 128). In this embodiment, the vendor 106 will have been pre-paid for any future purchases or transactions with the consumer 108. In another embodiment, the deposit of funds may be sent the vendor 106 via a third party, including an escrow, trust, or other account or entity.

The pre-paid transaction manager 102 may credit the vendor account balance for the vendor 106, which is useable by the consumer 108, with the deposit of funds and the bonus associated with the offer for which the consumer (qualified (process 130). Continuing the non-limiting example from above, if the user deposits over $100 in his or her consumer account, and the bonus associated with the offer for which the consumer 108 qualified is 20% of the deposit amount, the consumer's vendor account balance for the vendor 106 will include the deposit amount plus 20% of the deposit amount. For example, if the deposit amount is $200, the consumer's vendor account balance for the vendor 106 will be credited with $240.

The consumer 108 may spend all or a portion of his or her vendor-specific account balance in the consumer account 116 to purchase goods or services from that vendor 106, including the deposit amount and the bonus, using the consumer card 118 (data communication 132). In other embodiments, the consumer 108 may spend all or a portion of his or her vendor account balance in the consumer account 116 at the vendor 106 using one of the communication devices 110, such as a smartphone, or another process of identifying, approving, and/or accounting for transactions.

The transaction for which the consumer card 118 is used may be approved or denied (process 134). To approve or deny the transaction in process 134, the vendor 106 may access the consumer account 116, such as via the consumer card 118, to determine whether the consumer 108 has sufficient funds to make the purchase. The process 134 may be performed by the pre-paid transaction manager 102 by, e.g., comparing the purchase price with the balance in the consumer account 116 that is usable at the vendor 106. It will be appreciated that approval or denial of the transaction may be performed by any entity, depending on the embodiment, including the pre-paid transaction manager 102, the vendor 106, or a combination of these entities.

If the transaction is denied due to insufficient funds in the consumer account 116, the consumer 108 may have a variety of options by which to pay the difference. For example, the consumer 108 may add funds to his or her consumer account 116 usable at the vendor 106 via a kiosk, one of the communication devices 110 (e.g., a smart phone), any device that provides access to the pre-paid transaction manager 102 (e.g., any Internet-enabled device), etc. The consumer 108 may also have the option to pay the difference using an alternative payment method (e.g., credit card, cash, debit card, etc.). After the transaction occurs, the pre-paid transaction manager 102 may adjust the consumer's vendor account balance in the consumer account 116 to reflect the transaction (process 136). In one embodiment, an alert (e.g., text message, e-mail, audio, etc.) may be sent to the consumer 108 if the transaction is approved or denied, to notify the consumer 108 of his or her new post-transaction balance, or any other transaction-related purpose.

The illustrative embodiments may be used to manage pre-paid transactions between consumers 108 and vendors 106 that provide the consumer 108 with an incentive for pre-payments that are transferred directly to the vendor 106 prior to the consumer 108 claiming goods or services. In one embodiment, the point of sale transaction may be facilitated by a single card, or virtual card, that accesses discrete, pre-paid balances with several vendors.

The techniques, technologies, or media by which the components of the pre-paid transaction system 100 intercommunicate are numerous. For example, the pre-paid transaction system 100, or any portion thereof, may be part of a personal area network (PAN), a local area network (LAN), a campus area network (CAN), a metropolitan area network (MAP), or any other network type. Also, communication between any two of the elements in the pre-paid transaction system 100 may be direct or indirect. Data communication medium 138 between the laptop 112, or any other communication device 110, and the server 104 and the data communication medium 139 between the vendor 106 and server 104 may be any medium through which data can be communicated. For example, the data communication media 138, 139 may be wired or wireless data connections, and may utilize a virtual private network (VPN), multi-protocol label switching (MPLS), the Internet, or any other data communication media.

The data communication medium 140 between the base station 141 and the server 104 may be of the same or similar type as any of the non-limiting examples provided for the data communication media 138, 139. Wireless communication between the cellular phone 114, or any other mobile communication device, and the base station 141 may utilize any wireless standard for communicating data, such as CDMA (e.g., cdmaOne or CDMA2000), GSM, 3G, 4G, Edge, an over-the-air network, Bluetooth, etc. Any of the transactions occurring in the pre-paid transaction system 100 may be performed using secure SSL transactions. In one embodiment, the pre-paid transaction manager 102 may be implemented in the pre-paid transaction system 100 on a cloud computing-based format or platform. In yet another embodiment, the pre-paid transaction manager 102 may be implemented locally (e.g., as installable or deployable software) on any of the communication devices usable by the consumer 108 or the vendor 106.

In one example, the pre-paid transaction system 100 may utilize the Internet, with any combination of the data communication media 138, 139, 140 representing a worldwide collection of networks and gateways that use the Transmission Control Protocol Internet Protocol (TCP/IP) suite of protocols to communicate with one another. At the heart of the Internet is a backbone of high-speed data communication lines between major nodes or host computers, consisting of thousands of commercial, governmental, educational, and other computer systems that route data and messages. FIG. 1 is intended as an example, and not as an architectural limitation for the different illustrative embodiments.

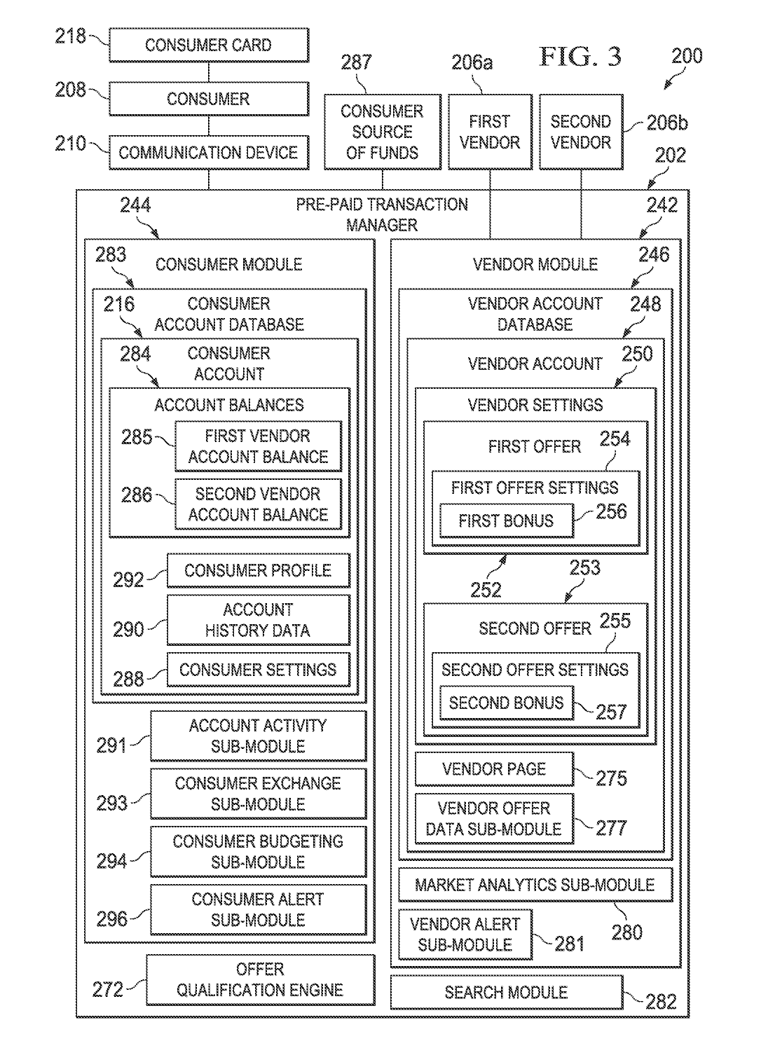

Referring to FIGS. 3 through 5, an illustrative embodiment of the pre-paid transaction manager 202 of the pre-paid transaction system 200 includes a vendor module 242, a consumer module 244, as well as other elements to implement or manage pre-payable transactions. Elements of FIGS. 3 through 5 that are analogous to elements in FIGS. 1 and 2 have been shown by indexing the reference numerals by 100. The vendor module 242 may include a vendor account database 246 that includes multiple vendor accounts, each corresponding to a particular vendor, such as vendors 206a, 206b. By way of non-limiting example and illustration, the vendor account database 246 of FIG. 3 includes a vendor account 248 for the first vendor 206a; however, any number of vendor accounts may be stored in the vendor account database 246, and such number of vendor accounts may depend on the number of vendors participating in the pre-paid transaction system 200.

The vendor account 248 for the first vendor 206a may include a set of vendor settings 250 that are definable or customizable by the first vendor 206a. As used herein, including in the claims, the term “set” may encompass a quantity of one or more. The vendor settings 250 that the vendor module 242 receives from the first vendor 206a may include any number of offers 252, 253 available to the consumer 208, and each of these offers 252, 253 from the first vendor 206a may include respective offer settings 254, 255. While the first vendor 206a may input any number of offers into their vendor account 248, for purposes of illustration, the vendor account 248 includes a first offer 252 and a second offer 253, each associated with first and second offer settings 254, 255, respectively. Each of the first and second offer settings 254, 255 may include a first and second bonus 256, 257, respectively.

The offer settings 254, 255 for the first and second offers 252, 253 may include criteria with which to determine whether the consumer 208 qualifies for the bonuses 256, 257 associated with the respective offer 252, 253. Examples of offer settings 254, 255 by which the consumer 208 may qualify for an offer 252, 253 are numerous. With reference to the first offer 252 by way of non-limiting example, the first offer settings 254 may include a minimum deposit amount, definable by the first vendor 206a, and the consumer 208 may qualify for the first bonus 256 if the consumer 208 deposits funds for the first vendor 206a in excess of the minimum deposit amount. In yet another example, the first offer 252 may include a minimum deposit amount and a maximum deposit amount, both definable by the first vendor 206a, and the consumer 208 may be awarded the first bonus 256 if a deposit of funds from the consumer 208 toward the first vendor 206a meets or exceeds the minimum deposit amount and is less than, or does not exceed, the maximum deposit amount.

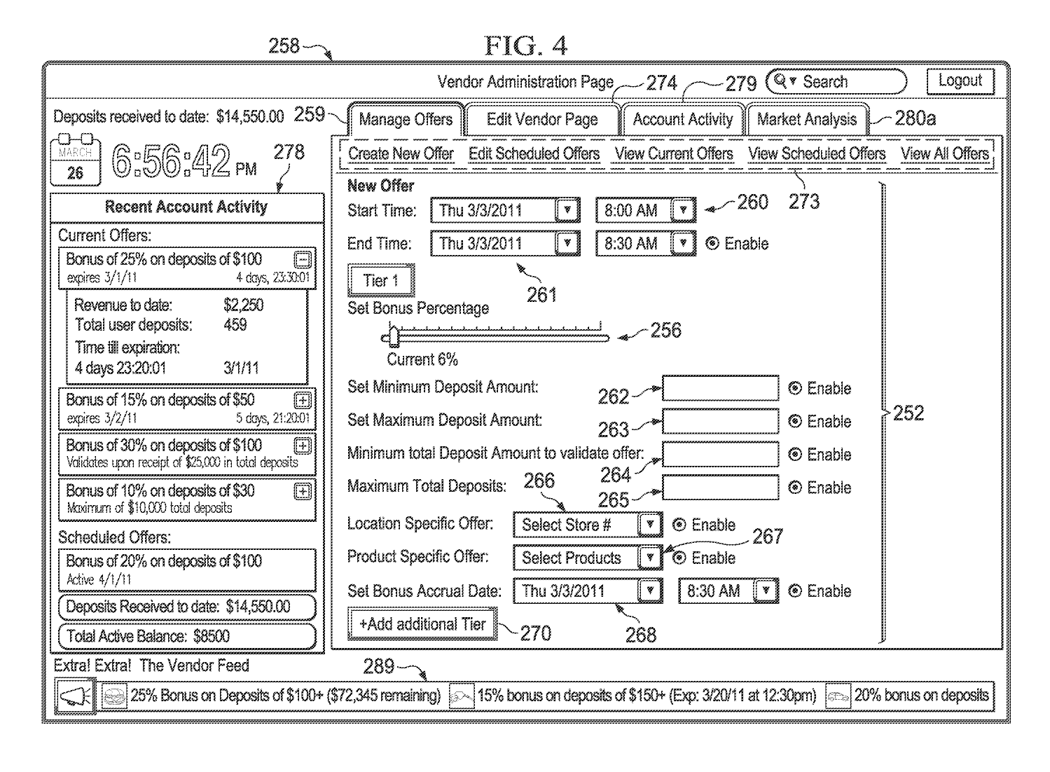

To further illustrate vendor customization, of the offer settings 254, 255 for the offers 252, 253 from the vendors 206a, 206b, reference is made to FIG. 4, which includes a graphical interface by which the vendors 206a, 206b may customize their respective offers. The vendor administration page 258 shown in FIG. 4 includes a manage offers tab 259 in which the first vendor 206a may customize multiple first offer settings 254 for the first offer 252. For example, the first vendor 206a may select an offer start time 260 and an offer end time 261 for the first offer 252. The offer start time 260 and the offer end time 261 may define the time period in which the first offer 252 is eligible for qualification by the consumer 208.

The vendor administration page 258 may also allow the first vendor 206a to select the first bonus 256 using the sliding scale shown in FIG. 4, or any other input method. Using the sliding scale shown in FIG. 4, the first bonus 256 may be defined in terms of a bonus percentage of the deposit amount from the consumer 208. However, in other embodiments, the first bonus 256 may be a defined amount of money (e.g., $50, $450, etc.). In another embodiment, the first bonus 256 may be any incentive from a vendor in exchange for receiving funds prior to loss of possession of inventory. The first vendor 206a may also set the minimum deposit amount 262 and the maximum deposit amount 263 allowable for the consumer 208 to qualify for the first bonus 256.

Other first offer settings 254 may also be selectable the first vendor 206a. For example, the first vendor 206a may input a minimum total deposit validation amount 264, which may be the minimum total deposit amount from all consumers, including the consumer 208, which must be collected by the pre-paid transaction manager 202 in order to validate, or enforce, the first offer 252. The first vendor 206a may also define a maximum total deposit amount 265, which may be the maximum total deposit amount deposited by all consumers, including the consumer 208, that may qualify for the first offer 252.

The first vendor 206a may also define one or more offer locations 266, which may be the specific locations at which the consumer 208 may redeem any funds or bonuses in his or her consumer account 216. For example, the first vendor 206a may select certain store numbers or stores in a certain city or state at which the consumer 208 may redeem funds in his or her consumer account 216 allocated for the first vendor 206a. The first vendor 206a may also select one or more offer products 267, which may be the products purchasable by the consumer 208 using the funds allocated for the first vendor 206a in his or her consumer account 216, including those products defined by the offer type chosen by the consumer 208. In another example, the first vendor 206a may also define a bonus accrual date 268, which may be the date on which the first bonus 256 accrues to the consumer 208. For example, if the consumer 208 qualifies for the first bonus 256 by depositing an amount exceeding the minimum deposit amount 262, the consumer 208 may receive his or her first bonus 256 into the consumer account 216 on the bonus accrual date 268 defined by the first vendor 206a.

The first vendor 206a may also define other types of first offer settings 254 by which the consumer 208 may qualify for the first offer 252. In one embodiment, the first vendor 206a may define first offer settings 254 that include the minimum deposit amount 262, a deposit frequency, and/or a deposit period. These offer settings may be used in a combination of ways in order to determine whether the consumer 208 may qualify for the first offer 252. For example, consumer 208 may be determined to have qualified for the first offer 252 if the consumer 208 deposits the minimum deposit amount 262 at the defined deposit frequency (e.g., once a week, once a month, once a quarter, etc.) for the deposit period (e.g., one month, one quarter, eight months, two years, etc.). In the case in which the consumer 208 deposits the minimum deposit amount 262 at the defined deposit frequency for the deposit period, the consumer 208 may be awarded the first bonus 256 (e.g., a percentage of one of the deposits, a percentage of the total deposit amount over the deposit period, a dollar amount, etc.). In another embodiment, the first vendor 206a may set the first offer settings 254 such that if the consumer 208 deposits an aggregate amount (e.g., $100, $1000, etc.) within a deposit period (e.g., one month, six months, one year, etc.), the consumer 208 is awarded the first bonus 256.

The vendor administration page 258 may also include a button 270 that allows the first vendor 206a to define additional offers or tiers of offers, such as the second offer 253. The first offer settings 254 for the first offer 252 may differ from the second offer settings 255 for the second offer 253. The first and second bonuses 256 and 257 may also differ from one another. By allowing tiered offers, the pre-paid transaction manager 202 may allow the vendors 206a, 206b to provide different bonus levels based on the amount deposited by the consumer 208, as well as other criteria. For example, the vendor 206a may input two or more tiered offers that award the consumer 208 progressively higher bonuses as the amount deposited by the consumer 208 increases.

By way of example, the first offer 252 may have a first minimum deposit amount and the first bonus 256 and the second offer 253 may have a second minimum deposit amount and the second bonus 257. The first and second minimum deposit amounts may differ from one another, and the first and second bonuses 256, 257 may differ from one another. For example, the first minimum deposit amount and the first bonus 256 may be higher than the second minimum deposit amount and the second bonus 257, respectively. The consumer 208 may qualify for either of the first, or second offers 252, 253 based on whether a deposit of funds from the consumer 208 meets or exceeds the first or second minimum deposit amounts associated with the first and second offers 252, 253, respectively. For example, if the deposit of funds from the consumer 208 for the first vendor 206a meets or exceeds the first minimum deposit amount, the consumer 208 may qualify the first bonus 256. On the other hand, if the consumer 208 deposits funds meeting or exceeding the second minimum deposit amount, the consumer 208 may be awarded the second bonus 257. The consumer account 216 may then be credited with either the first bonus 256 or the second bonus 257 based on which of the first or second minimum deposit amounts are met or exceeded by the deposit from the consumer 208.

In another embodiment, the first offer settings 254 may include a first minimum deposit amount, a first maximum deposit amount, and the first bonus 256. The second offer settings 255 for the second offer 253 may include a second minimum deposit amount, a second maximum deposit amount, and the second bonus 257. The consumer 208 may qualify for the first bonus 256 if a deposit of funds from the consumer 208 for the first vendor 206a meets or exceeds the first minimum deposit amount but does not exceed the first maximum deposit amount. On the other hand, the consumer 208 may qualify for the second offer 253, and therefore be awarded the second bonus 257, if the deposit of funds from the consumer 208 meets or exceeds the second minimum deposit amount but does not exceed the second maximum deposit amount. Based on which of the two offers 252, 253 qualified for by the consumer 208, either the first or second bonus 256, 257 may be credited to the consumer account 216 for the consumer 208, along with the deposit of funds from the consumer 208 for the first vendor 206a. In these examples, crediting the consumer account 216 may be in response to the pre-paid transaction manager 202, or an offer qualification engine 272 described below, determining that the consumer 208 qualifies for one of the first or second offers 252, 253.

In one embodiment, the vendor administration page 258 may include a set of selectable buttons 273 selectable by the first vendor 206a to perform one or more functions. For example, the set of buttons 273 may include: an option to create a new offer; an option to edit offers that are scheduled to start, such as via the offer start time 260, at a particular or future time; an option to view current offers inputted by the first vendor 206a; an option to view scheduled offers; an option to view all offers, both current and scheduled, etc.

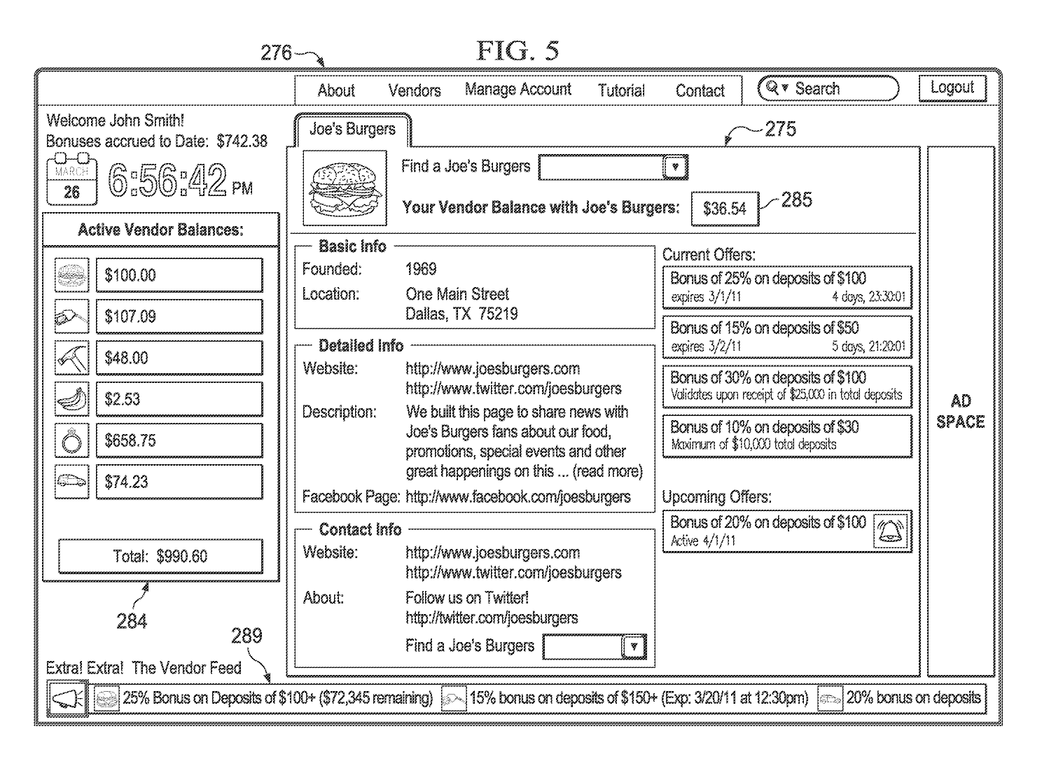

In one embodiment, the vendor administration page 258 may include an edit vendor page tab 274 that allows the first vendor 206a to create, edit, or customize a vendor page 275. The vendor page 275 may be a page that presents information about the first vendor 206a, including any associated offers, to the consumer 208. A non-limiting example of the vendor page 275 is shown in FIG. 5, which illustrates an embodiment of a consumer interface 276. The vendor page 275 may be customized by the first vendor 206a, and may include the offers 252, 253 offered by the first vendor 206a. In the non-limiting example of FIG. 5, the vendor page 275 shows the first vendor 206a to have four current offers and one upcoming, or scheduled, offer. Each of the offers shown on the vendor page 275 also includes offer settings, such as the bonus percentage and the minimum deposit amount that are associated with each offer. The first vendor 205a may also customize the vendor page 275 to include data about the first vendor 206a, such as a founding date, location, website, description, social media link or page, location search functionality, the balance of funds currently available to the consumer 208 for spending at the first vendor 206a, etc.

In one embodiment, the vendor account 248 for the first vendor 206a, and indeed any vendor account in the vendor account database 246, may include a vendor offer data sub-module 277. The vendor offer data sub-module 277 may present offer data 278 for any offers 252, 253 from the first vendor 206a. As shown in FIG. 4, non-limiting examples of offer data 278 that may be presented for each offer, both current and scheduled, from the first vendor 206a include revenue or deposits received to date, the total number of users that have deposited funds qualifying for the offer, an amount of time left until expiration of the offer, etc. As shown in the bottom-left portion of the vendor administration page 258, the offer data 278 may also include the total of all deposits from all consumers, including the consumer 208, to date, as well as a total active balance. The total active balance may represent the amount of unused funds, or funds for which the first vendor 206a is liable in future transactions. In one embodiment, the offer data 278 may be presented by the vendor offer data sub-module 277 in an account activity tab 279 on the vendor administration page 258.

The vendor module 242 may also include a market analytics sub-module 280 that facilitates vendor selection and/or optimization of offers based on prior offer data and performance, including the offer data 278, for the multiple vendors using the pre-paid transaction manager 202. For example, the market analytics sub-module 280 may assist the first and second vendors 206a, 206b in determining which types of offers are most, or least, effective in their respective market sectors (e.g., retail, food, gas, auto, etc.). The market analytics sub-module 280 may also inform the vendors 206a, 206b of typical or average consumer responses, such as average or aggregate deposit amounts, to different types of offers having different types of offer settings. The market analytics sub-module 280 may also provide data about the amount of time it takes a deposit pool to be used under certain circumstances and the effects of various offer settings on deposit volume, frequency, popularity, etc. In one embodiment, the market analytics data associated with the market analytics sub-module 280 may be accessible via the vendor administration page 258 in a market analysis tab 280a.

In one embodiment, the vendor module 242 may include a vendor alert sub-module 281 that may alert any of the vendors 206a, 206b when a certain condition is met. For example, the vendor alert sub-module 281 may alert the first vendor 206a when the maximum total deposits 265 has been reached, the minimum total deposit amount to validate an offer 264 has been reached, when a particular offer has expired, when a scheduled offer has become current or active, when a current offer has ended, or any other circumstance or combination of circumstances for which the first vendor 206a desires to be alerted.

Using the communication device 210, the consumer 208 may use the consumer module 244 to, among other things, interact, with the pre-paid transaction manager 202. In one example, the consumer 208 may select one of the vendors 206a, 206b that the consumer 208 desires to pre-pay for transactions. The consumer 208 may locate a desired vendor, such as the first vendor 206a, by using a browsing feature, which allows the consumer 208 to browse vendors using certain criteria (e.g., market sector, location, alphabetical order, popularity, etc.).

The pre-paid transaction manager 202 may also include a search module 282 that allows the consumer 208 to search for any of the vendors participating in the pre-paid transaction manager 202 using one or more search terms. An example of a search field with which the consumer 208 may interact with the search module 282 is shown in the top-right corner of the vendor administration page 258 and the consumer interface 276 in FIGS. 4 and 5, respectively. The search module 282 may also track the consumer 208, by, e.g., using the consumer's IP address, to present local offers or vendors to the consumer 208. When the consumer 208 searches for vendors, the search results list may be sorted in any manner, such as by alphabetical order, popularity, bonus percentage or amount, location, consumer preferences or settings, etc.

The consumer module 244 may include a consumer account database 283 that includes any number of consumer accounts, such as the consumer account 216, for any number of consumers, such as the consumer 208. In the illustrative example of FIG. 3, the consumer account 216 is associated with the consumer 208, although in other embodiments many different consumer accounts may be stored in the consumer account database 283 for many different consumers. The consumer account 216 may include account balances 284 that have respective vendor account balances 285, 286 for each vendor 206a, 206b. In the non-limiting example of FIG. 3, the consumer 208 has a first vendor account balance 285 containing funds spendable at the first vendor 206a and a second vendor account balance 286 containing funds spendable at the second vendor 206b. It will be appreciated that the balance in the first vendor account balance 285 may, in one embodiment, account for the monetary liability of the first vendor 206a; this liability may include both deposits of funds from the consumer 208 into the first vendor account balance 285, as well as any bonuses awarded to the consumer 208 by the first vendor 206a. It will also be appreciated that, in one embodiment, although the first vendor account balance 285 may contain both fund deposits from the consumer 208 and any bonuses awarded to the consumer 208 by the first vendor 206a, only the portion of the first vendor account balance 285 corresponding to fund deposits from the consumer 208 will have been directly transferred to the first vendor 206a prior to a transaction using those fund deposits.

In one embodiment, the offer qualification engine 272 may determine whether a deposit of funds received from the consumer 208 qualifies the consumer 208 for a particular offer, such as the first or second offers 252, 253. For example, the consumer 208 may select the first vendor 206a so that the first and second offers 252, 253 from the first vendor 206a are presented to the consumer 208 on, e.g., the consumer interface page 276. The consumer 208 may then deposit funds into the first vendor account balance 285 associated with the first vendor 206a to attempt to qualify for one of the first or second offers 252, 253 from the first vendor 206a. The criteria by which the consumer 208 may qualify for the first or second offers 252, 253 may be determined by the first or second offer settings 254, 255, respectively, including those discussed above. In one embodiment, using the amount deposited by the consumer 208, as well as any offer settings 254, 255 definable by the first vendor 206a, the offer qualification engine 272 may determine whether the consumer 208 qualifies for one of the offers 252, 253 from the first vendor 206a. If the consumer 208 qualifies for one of the first or second offers 252, 253, either the first or second bonus 256, 257, respectively, may be credited to the first vendor account balance 285 along with the deposit of funds from the consumer 208.

In one embodiment, the consumer interface page 276 may inform the consumer 208 of any of the vendor account balances 285, 286. With reference to FIG. 5, an example in which the vendor account balances for six different vendors is shown on the left side of the consumer interface page 276. Each of the vendor account balances shown in FIG. 5 may be accompanied by a logo, name, or other identifier that aids the consumer 208 in identifying which vendor is associated with each of the vendor account balances. The first vendor account balance 285 may be displayed to the consumer 208 on the vendor page 275 as well. The consumer interface page 276, in one embodiment, may also include space for advertisements, as shown on the right side of the consumer interface page 276 of FIG. 5.

The consumer's deposit of funds into one of the account balances 284 may be performed from any source of funds 287 and using any technique (e.g., direct deposit, check, credit card, debit card, wire transfer, etc.). In one embodiment, the consumer account 216 may include consumer settings 288 that allow the consumer 208 to determine the source of funds 287 or the method by which a deposit is performed. In another example, the consumer 208 may define the consumer settings 288 to implement an auto-debit option in which the consumer 208 deposits funds into one of the account balances 284 by auto-debiting the source of funds 287 to the user-defined vendor account balance 285 or 286. The consumer settings 288 defined by the consumer 208 may direct the consumer module 244 to deposit a consumer-defined amount of funds on a consumer-defined periodic basis (e.g., $100 every month, $5 every day, $1000 every 6 months, etc.). The consumer 208 may also set up an auto-debit of funds into one or more of the vendor account balances 285, 286 contingent upon a bonus from one of the vendors 206a, 206b being above a certain threshold. The vendors 206a, 206b may also define their offer settings to award a bonus to the consumer 208 contingent upon, among other things, the auto-debiting of funds; for example, the first offer settings 254 may be defined such that the first bonus 256 is awarded to the consumer 208 if the consumer 208 makes a minimum deposit amount by a certain date each month by auto-debit for a vendor-defined number of months.

The funds that are credited to the account balances 284 may be usable by the consumer 208 using the consumer card 218. The consumer card 218 may be a physical card, may be an electronic, or similar, card, or may be any other process of determining consumer identity, account balances, and/or adjusting balances based on a transaction. In one embodiment, the pre-paid transaction manager 202 may associate the consumer account 216 with the consumer card 218 so that the consumer 208 may use the consumer card 218 to spend the account balances 284 contained in the consumer account 216.

As shown in FIGS. 4 and 5, either or both of the vendor administration page 258 or the consumer interface page 276 may include a scrolling feed 289 that displays one or more offers from any number of vendors 206a, 206b. The content of the scrolling feed 289 may be defined by the consumer settings 288. For example, the consumer 208 may define the scrolling feed 289 to display only offers in his or her local area, offers that meet or exceed a certain bonus threshold, offers in a particular market sector (e.g., retail, food, gas, auto, etc.), etc.

In one embodiment, the consumer account 216 may include account history data 290 that includes data about transactions involving the consumer 208, such as transactions between the consumer 208 and either or both of the pre-paid transaction manager 202 or any of the vendors 206a, 206b. For example, the account history data 290 may include any deposits from the consumer 208, any offers or bonuses qualified for by the consumer 208, the rate of spending by the consumer 208, charts, graphs, and other visual aids regarding transactions by the consumer 208, etc.

In one embodiment, the consumer module 244 may include an account activity sub-module 291 that may interface with the consumer 208 to present the consumer 208 with data regarding past transactions associated with the consumer account 216, including the account history data 290. The consumer account 216 may also include a consumer profile 292 that includes data about the consumer 208. The data in the consumer profile 292 may be inputted by the consumer 208, or collected from another source (e.g., internet cookies, third parties, etc.). Non-limiting examples of the type of data that may be included in the consumer profile 292 include the consumer's name, contact information, account or financial information, credit history, user comments, social networking links or data, etc.

The pre-paid transaction manager 202 may also allow the consumer 208 to deposit funds on behalf of someone else. In one embodiment, the consumer 208 may provide funds spendable at one of the vendors 206a, 206b to a person other than the consumer 208. For example, the consumer 208 may deposit funds into a consumer account accessible and spendable by a dependent, a receiver of the gift, an employee, etc. The person receiving the funds from the consumer 208 may be issued a separate consumer account or consumer card that allows the receiver of funds to spend his or her balance toward the vendor for which the balance applies.

In one example, the consumer 208 may deposit funds for another person in their respective consumer account, while retaining any bonuses accruing as a result of that deposit of funds. To provide a non-limiting example, the consumer 208 may deposit $100 into a vendor account balance spendable by a person other than himself or herself at the first vendor 206a. If the $100 deposit of funds qualifies the consumer 208 for a bonus, such as the first bonus 256, the first bonus 256 may be credited to the first vendor account balance 285 for the consumer 208. Thus, the consumer 208 retains any bonuses that result from his or her deposit of funds, while giving the original deposit of funds to another person.

In some cases, the multiple consumers using the pre-paid transaction manager 202 may collect vendor account balances usable towards particular vendors and desire to trade those vendor account balances with one another. The consumer module 244 may include a consumer exchange sub-module 293 to allow for such trades between consumers. For example, if a first consumer has a vendor account balance usable towards the first vendor 206a and a second consumer has a vendor account balance spendable at the second vendor 206b, the first and second consumers may trade balances with one another so that the first consumer may spend funds at the second vendor 206b and the second consumer may spend funds at the first vendor 206a.

In one embodiment, the consumer module 244 may also include a consumer budgeting sub-module 294 to facilitate consumer budgeting of funds. For example, consumer budgeting sub-module 294 may inform the consumer 208 where they have spent their account balances 284 by, e.g., showing the consumer 208 the proportion of his or her overall account balances 284 going to certain vendors or market sectors. The consumer budgeting sub-module 294 may present such budgeting data to the consumer 208 in any format, such as a bar graph, pie chart, etc. In another embodiment, the consumer budgeting sub-module 294 may allow the consumer 208 to enter his or her paycheck amount and allocate portions of his or her paycheck towards certain vendors or market sectors. In this embodiment, the consumer 208 may further elect to auto-debit the consumer's source of funds 287 toward the allocated vendors or market sectors. The consumer budgeting sub-module 294 may allow the consumer 208 to budget his or her funds and/or provide predictability for periodic or other expenses.

The consumer module 244 may also include a consumer alert sub-module 296 that may alert the consumer 208 in any manner (e.g., audio alert, visual art, e-mail alert, text alert, etc.) according to the consumer's consumer settings 288. For example, the consumer 208 may select to be alerted when any of his or her account balances 284 reach a certain threshold, when a transaction is made, when the consumer 208 is either approved or denied for a transaction, when a particular vendor makes an offer, when an offer meets certain consumer criteria (e.g., an offer that meets or exceeds a certain bonus amount), etc.

Using the pre-raid transaction manager 202, consumers may interface with vendors to allow for pre-paid transactions in a flexible, convenient, and cost-saving manner. The pre-paid transaction manager 202 may also, in one embodiment, provide flexibility to allow for the provision of gifts, as well as the distribution of funds to dependents, employees, etc. In the case of dependents, a parent may, for example, keep track of the expenses of his or her children.

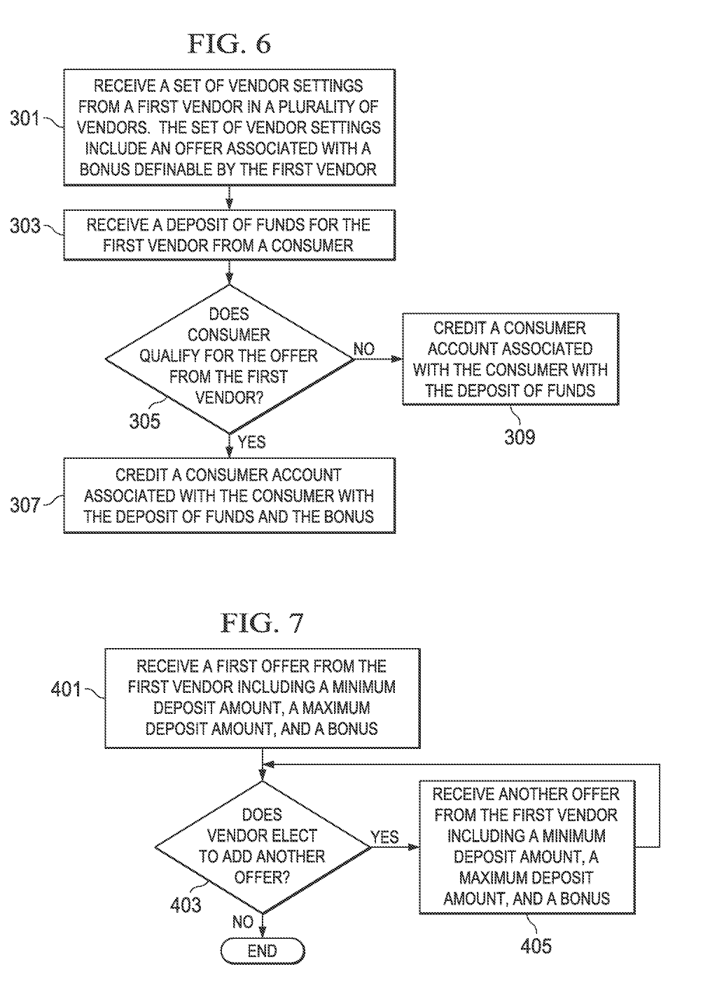

Referring to FIG. 6, an illustrative embodiment of a process for managing pre-paid transactions, which may be implemented by the pre-paid transaction manager 102, 202 in FIG. 1 or 2, includes receiving a set of vendor settings from a first vendor in a plurality of vendors (step 301). A set of vendor settings may include an offer associated with a bonus definable by the first vendor. The process may include receiving a deposit of funds for the first vendor from a consumer (step 303).

The process may determine whether the consumer qualifies for the offer from the first vendor (step 305). If the process determines that the consumer qualifies for the offer from the first vendor, the process may credit a consumer account associated with the consumer with the deposit of funds and the bonus (step 307). Returning to step 305, if the process determines that the consumer does not qualify for the offer from the first vendor, the process may credit the consumer account associated with the consumer with the deposit of funds (step 309). The account balances in the consumer account may be spendable at the first vendor using a consumer card.

Referring to FIG. 7, an illustrative embodiment of a process for receiving offers from a vendor may include receiving a first offer from the first vendor including a minimum deposit amount, a maximum deposit amount, and a bonus (step 401). The process may determine whether the vendor elects to add another offer (step 403). If the vendor elects to add another offer, the process may receive another offer from the first vendor including a minimum deposit amount, a maximum deposit amount, and a bonus (step 405). The process may then return to step 403. Returning to step 403, if the process determines that the vendor does not elect to add another offer, the process may terminate.

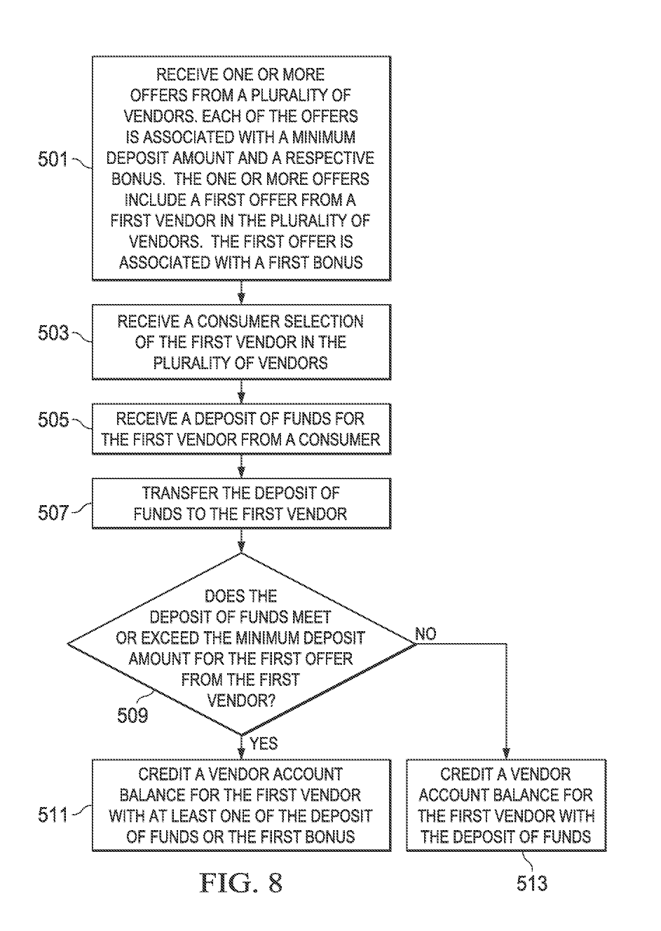

Referring to FIG. 8, another illustrative embodiment of a process for managing pre-paid transactions, which may be implemented by a pre-paid transaction manager 102, 202 in FIG. 1 or 2, includes receiving one or more offers from a plurality of vendors (step 501). Each of the offers may be associated with a minimum deposit amount and a respective bonus. The one or more offers may include a first offer from a first vendor in the plurality of vendors. The first offer may be associated with a first bonus.

The process may receive a consumer selection of the first vendor in the plurality of vendors (step 503). The process may receive a deposit of funds for the first vendor from a consumer (step 505). The process may transfer the deposit of funds to the first vendor (step 507).

The process may determine whether the deposit of funds meets or exceeds the minimum deposit amount for the first offer from the first vendor (step 509). If the process determines that the deposit of funds meets or exceeds the minimum deposit amount for the first offer from the first vendor, the process may credit a vendor account balance for the first vendor with at least one of the deposit of funds or the first bonus (step 511). Returning to step 509, if the process determines that the deposit of funds does not meet or exceed the minimum deposit amount for the first offer from the first vendor, the process may credit a vendor account balance for the first vendor with the deposit of funds (step 513). The vendor account balance may be a part of the consumer account, and may be spendable at the first vendor. Also, after steps 511 or 513, the process may post a vendor liability reflecting either or both of the deposit of funds or the first bonus, and the vendor liability may include an amount for which the first vendor is liable for future products or services.

The flowcharts and block diagrams in the different depicted embodiments illustrate the architecture, functionality, and operation of some possible implementations of apparatus, methods and computer program products. In this regard, each block in the flowchart or block diagrams may represent a module, segment, or portion of code, which comprises one or more executable instructions for implementing the specified function or functions. In some alternative implementations, the function or functions noted in the block may occur out of the order noted in the Figures. For example, in some cases, two blocks shown in succession may be executed substantially concurrently, or the blocks may sometimes be executed in the reverse order, depending upon the functionality involved.

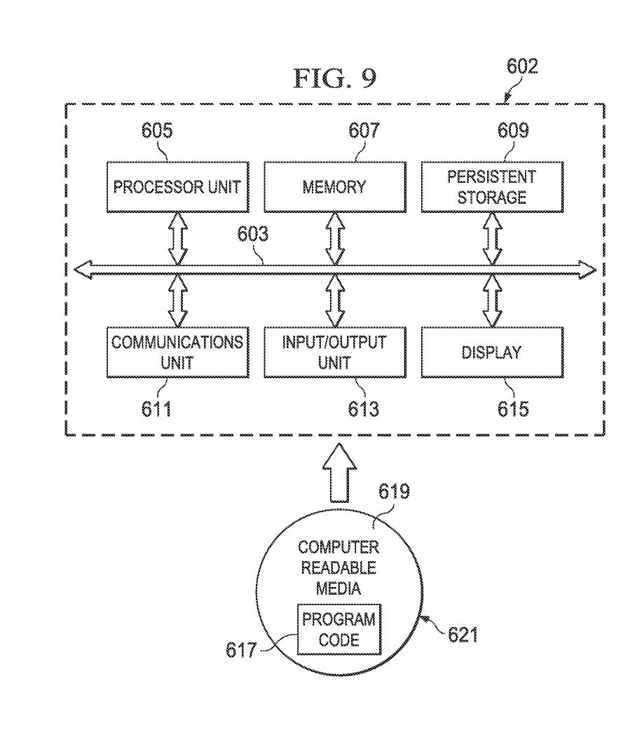

Referring to FIG. 9, a block diagram of a computing device 602 is shown in which the illustrative embodiments may be implemented. In one embodiment, the computing device 602 may be the server 104 described in FIG. 1. In another embodiment, the pre-paid transaction manager 102, 202 described in FIGS. 1 through 5 may be implemented on the computing device 602. Computer-usable program code or instructions implementing the processes used in the illustrative embodiments may be located on the computing device 602. The computing device 602 includes a communications fabric 603, which provides communications between a processor unit 605, a memory 607, a persistent storage 609, a communications unit 611, an input/output (I/O) unit 613, and a display 615.

The processor unit 605 serves to execute instructions for software that may be loaded into the memory 607. The processor unit 605 may be a set of one or more processors or may be a multi-processor core, depending on the particular implementation. Further, the processor unit 605 may be implemented using one or more heterogeneous processor systems in which a main processor is present with secondary processors on a single chip. As another illustrative example, the processor unit 605 may be a symmetric multi-processor system containing multiple processors of the same type.

The memory 607, in these examples, may be, for example, a random access memory or any other suitable volatile or non-volatile storage device. The persistent storage 609 may take various forms depending on the particular implementation. For example, the persistent storage 609 may contain one or more components or devices. For example, the persistent storage 609 may be a hard drive, a flash memory, a rewritable optical disk, a rewritable magnetic tape, or some combination of the above. The media used by the persistent storage 609 also may be removable. For example, a removable hard drive may be used for the persistent storage 609.

The communications unit 611, in these examples, provides for communications with other data processing systems or communication devices. In these examples, the communications unit 611 may be a network interface card. The communications unit 611 may provide communications through the use of either or both physical and wireless communication links.

The input/output unit 613 allows for the input and output of data with other devices that may be connected to the computing device 602. For example, the input/output unit 613 may provide a connection for user input through a keyboard and mouse. Further, the input/output unit 613 may send output to a processing device. In the case in which the computing device 602 is a cellular phone, the input/output unit 613 may also allow devices to be connected to the cellular phone, such as microphones, headsets, and controllers. The display 615 provides a mechanism to display information to a user, such as a graphical user interface.

Instructions for the operating system and applications or programs are located on the persistent storage 609. These instructions may be loaded into the memory 607 for execution by the processor unit 605. The processes of the different embodiments may be performed by the processor unit 605 using computer-implemented instructions, which may be located in the memory 607. These instructions are referred to as program code, computer-usable program code, or computer-readable program code that may be read and executed by a processor in the processor unit 605. The program code in the different embodiments may be embodied on different physical or tangible computer-readable media, such as the memory 607 or the persistent storage 609.

Program code 617 is located in a functional form on a computer-readable media, or computer-readable storage media, 619 and may be loaded onto or transferred to the computing device 602 for execution by the processor unit 605. The program code 617 and the computer-readable media 619 form computer program product 621 in these examples. In one embodiment, the computer program product 621 is the pre-paid transaction manager 102, 202 described in FIGS. 1 through 5, respectively. In this embodiment, the program code 617 may include computer-usable program code capable of receiving a set of vendor settings from a first vendor in a plurality of vendors. The set of vendor settings includes an offer associated with a bonus definable by the first vendor. The program code 617 may also include computer-usable program code capable of receiving a deposit of funds for the first vendor from a consumer, determining whether the consumer qualifies for the offer from the first vendor, and crediting a consumer account associated with the consumer with the deposit of funds and the bonus in response to determining that the consumer qualifies for the offer from the first vendor. The deposit of funds and the bonus is spendable at the first vendor using a consumer card (or another process of consumer identification and/or balance information management) associated with the consumer account.

In another embodiment, the program code 617 may include computer-usable program code capable of receiving one or more offers from a plurality of vendors. Each of the offers is associated with a minimum deposit amount and a respective bonus. The one or more offers includes a first offer from a first vendor in the plurality of vendors. The first offer is associated with a first bonus. The program code 617 may also include computer-usable program code capable of receiving a consumer selection of the first vendor in the plurality of vendors, receiving a deposit of funds for the first vendor from a consumer, determining whether the deposit of funds meets or exceeds the minimum deposit amount for the first offer from the first vendor, and crediting a vendor account balance, associated with the first vendor, in a consumer account with at least one of the deposit of funds or the first bonus in response to determining that the deposit of funds meets or exceeds the minimum deposit amount for the first offer from the first vendor. The deposit of funds and the first bonus is spendable at the first vendor. Any combination of the above-mentioned computer-usable program code may be implemented in the program code 617, and any functions of the illustrative embodiments may be implemented in the program code 617.

In one example, the computer-readable media 619 may be in a tangible form, such as, for example, an optical or magnetic disc that is inserted or placed into a drive or other device that is part of the persistent storage 609 for transfer onto a storage device, such as a hard drive that is part of the persistent storage 609. In a tangible form, the computer-readable media 619 also may take the form of a persistent storage, such as a hard drive or a flash memory that is connected to the computing device 602. The tangible form of the computer-readable media 619 is also referred to as computer recordable storage media.

Alternatively, the program code 617 may be transferred to the computing device 602 from the computer-readable media 619 through a communication link to the communications unit 611 or through a connection so the input/output unit 613. The communication link or the connection may be physical or wireless in the illustrative examples. The computer-readable media 619 also may take the form of non-tangible media, such as communication links or wireless transmissions containing the program code 617. In one embodiment, the program code 617 is delivered to the computing device 602 over the Internet.

The different components illustrated for the computing device 602 are not meant to provide architectural limitations to the manner in which different embodiments may be implemented. The different illustrative embodiments may be implemented in a data processing system including components in addition to or in place of those illustrated for computing device 602. Other components shown in FIG. 9 can be varied from the illustrative examples shown.

As one example, a storage device in the computing device 602 is any hardware apparatus that may store data. The memory 607, the persistent storage 609, and the computer-readable media 619 are examples of storage devices in a tangible form.

In another example, a bus system may be used to implement the communications fabric 603 and may be comprised of one or more buses, such as a system bus or an input/output bus. Of course, the bus system may be implemented using any suitable type of architecture that provides for a transfer of data between different components or devices attached to the bus system. Additionally, the communications unit 611 may include one or more devices used to transmit and receive data, such as a modem or a network adapter. Further, a memory may be, for example, the memory 607 or a cache such as found in an interface and memory controller hub that may be present in the communications fabric 603.

As used herein, including in the claims, the terms first, second, third, etc. used in relation to an element (e.g., first offer, second offer, etc.) are for reference or identification purposes only, and these terms, unless otherwise indicated, are not intended to describe or suggest a number, order, source, purpose, or substantive quality for any element for which such a term is used.

Although the illustrative embodiments described herein have been disclosed in the context of certain illustrative, non-limiting embodiments, it should be understood that various changes, substitutions, permutations, and alterations can be made without departing from the scope of the invention as defined by the appended claims. It will be appreciated that any feature that is described in a connection to any one embodiment may also be applicable to any other embodiment.

What is claimed is:

1. A method for managing pre-paid transactions, the method comprising:
receiving a set of vendor settings from a first vendor in a plurality of vendors, the set of vendor settings comprising an offer associated with a bonus definable by the first vendor;
receiving a deposit of funds for the first vendor from a consumer;
determining whether the consumer qualifies for the offer from the first vendor; and
in response to determining that the consumer qualifies for the offer from the first vendor, crediting a consumer account associated with the consumer with the deposit of funds and the bonus, the deposit of funds and the bonus spendable at the first vendor using a consumer card associated with the consumer account.

2. The method of claim 1, further comprising:
sending the deposit of funds to the first vendor in response to receiving the deposit of funds for the first vendor from the consumer.

3. The method of claim 1, wherein the bonus is a vendor-defined percentage of the deposit of funds from the consumer.

4. The method of claim 1, wherein the offer comprises a minimum deposit amount; and
wherein determining whether the consumer qualifies for the offer from the first vendor comprises determining whether the deposit of funds meets or exceeds the minimum deposit amount.

5. The method of claim 1, wherein the offer comprises a minimum deposit amount and a maximum deposit amount; and
wherein determining whether the consumer qualifies for the offer from the first vendor comprises determining whether the deposit of funds meets or exceeds the minimum deposit amount and whether the deposit of funds does not exceed the maximum deposit amount.

6. The method of claim 1, wherein the consumer account comprises a set of vendor account balances, each of the set of vendor account balances comprising a funds balance spendable at one of the vendors in the plurality of vendors; and
wherein crediting the consumer account with the deposit of funds and the bonus comprises crediting vendor account balance for first vendor with the deposit of funds and the bonus.

7. The method of claim 1, wherein receiving the set of vendor settings from the first vendor comprises:
receiving a first offer comprising a first minimum deposit amount and a first bonus; and
receiving a second offer comprising a second minimum deposit amount and a second bonus, the second minimum deposit amount different from the first minimum deposit amount, the second bonus different from the first bonus;
wherein the method further comprises receiving a consumer selection of one of the first offer or the second offer;
wherein determining whether the consumer qualifies for the offer from the first vendor comprises determining whether the consumer qualifies for the one of the first offer or the second offer selected by the consumer, the consumer qualifying for the first offer if the deposit of funds meets or exceeds the first minimum deposit amount, the consumer qualifying for the second offer if the deposit of funds meets or exceeds the second minimum deposit amount;
wherein crediting the consumer account with the deposit of funds and the bonus comprises crediting the consumer account with the deposit of funds and one of the first bonus or the second bonus based on which of the first offer or the second offer, respectively, is selected by and qualified for by the consumer; and
wherein crediting the consumer account with the deposit of funds and one of the first bonus or the second bonus is in response to determining that the consumer qualifies for the one of the first offer or the second offer selected by the consumer.

8. The method of claim 1, wherein receiving the set of vendor settings from the first vendor comprises:
receiving a first offer comprising a first minimum deposit amount, a first maximum deposit amount, and a first bonus; and
receiving a second offer comprising a second minimum deposit amount, a second maximum deposit amount, and a second bonus, the second minimum deposit amount different from the first minimum deposit amount, the second maximum deposit amount different from the first maximum deposit amount, the second bonus different from the first bonus;
wherein the method further comprises receiving a consumer selection of one of the first offer or the second offer;
wherein determining whether the consumer qualifies for the offer from the first vendor comprises determining whether the consumer qualifies for the one of the first offer or the second offer selected by the consumer, the consumer qualifying for the first offer if the deposit of funds meets or exceeds the first minimum deposit amount and does not exceed the first maximum deposit amount, the consumer qualifying for the second offer if the deposit of funds meets or exceeds the second minimum deposit amount and does not exceed the second maximum deposit amount;
wherein crediting the consumer account with the deposit of funds and the bonus comprises crediting the consumer account with the deposit of funds and one of the first bonus or the second bonus based on which of the first offer or the second offer, respectively, is selected by and qualified for by the consumer; and
wherein crediting the consumer account with the deposit of funds and one of the first bonus or the second bonus is in response to determining that the consumer qualifies for the one of the first offer or the second offer selected by the consumer.

9. The method of claim 1, wherein receiving the set of vendor settings from the first vendor comprises receiving a plurality of offers from the first vendor, each of the plurality of offers comprising a respective bonus and respective offer settings;
wherein the method further comprises receiving a consumer selection of one of the plurality of offers from the first vendor;
wherein determining whether the consumer qualifies for the offer from the first vendor comprises determining that the consumer qualifies for the one of the plurality of offers selected by the consumer using the offer settings of the one of the plurality of offers selected by the consumer; and
wherein crediting the consumer account with the deposit of funds and the bonus comprises crediting the consumer account with the deposit of funds and the respective bonus for the one of the plurality of offers for which the consumer is qualified.

10. The method of claim 1, further comprising:
displaying a scrolling feed to consumer, the scrolling feed comprising one or more offers from the plurality of vendors.

11. The method of claim 1, wherein receiving the deposit of funds for the first vendor from the consumer comprises auto-debiting a source of funds associated with the consumer on a user-defined periodic basis.

12. The method of claim 1, wherein the offer comprises a minimum deposit amount, a deposit frequency, and a deposit period; and
wherein determining whether the consumer qualifies for the offer from the first vendor comprises determining whether the consumer deposited the minimum deposit amount at the deposit frequency for the deposit period.

13. The method of claim 1, further comprising:
presenting one or more offers from the first vendor on a vendor page, the vendor page customizable by the first vendor.

14. The method of claim 1, wherein the offer comprises a set of offer settings, the set of offer settings comprising at least one of a minimum deposit amount, a maximum deposit amount, a deposit frequency, a deposit period, an offer start time, an offer end time, a bonus percentage, a minimum total deposit validation amount, a maximum total deposit amount, one or more offer locations, one or more offer products, or a bonus accrual date.

15. A method for managing pre-paid transactions, the method comprising:
receiving one or more offers from a plurality of vendors, each of the offers associated with a minimum deposit amount and a respective bonus, the one or more offers comprising a first offer from a first vendor in the plurality of vendors, the first offer associated with a first bonus;
receiving a consumer selection of the first offer from the first vendor in the plurality of vendors;
receiving a deposit of funds for the first vendor from a consumer;
determining whether the deposit of funds meets or exceeds the minimum deposit amount for the first offer from the first vendor; and
in response to determining that the deposit of funds meets or exceeds the minimum deposit amount for the first offer from the first vendor, crediting a vendor account balance, associated with the first vendor, in a consumer account with at least one of the deposit of funds or the first bonus, the deposit of funds and the first bonus spendable at the first vendor.

16. The method of claim 15, wherein receiving the deposit of funds for the first vendor from the consumer comprises receiving the deposit of funds for the first vendor from a first consumer associated with a first consumer account; and
wherein crediting the vendor account balance in the consumer account with at least one of the deposit of funds or the first bonus comprises:
crediting a first vendor account balance for the first consumer account for the first consumer with the first bonus; and
crediting a second vendor account balance for a second consumer account for a second consumer with the deposit of funds.

17. The method of claim 15, wherein crediting the vendor account, balance in the consumer account with at least one of the deposit of funds or the first bonus comprises crediting the vendor account balance with the deposit of funds and the first bonus, the vendor account balance associated with the consumer account for the consumer.

18. The method of claim 17, further comprising:
associating the consumer account with at least one of a consumer card or a communication device, the at least one of a consumer card or a communication device usable to spend funds in the consumer account at the first vendor.

19. A pre-paid transaction manager comprising:
a vendor module comprising a plurality of vendor accounts for a plurality of vendors, each of the plurality of vendors having at least one of the plurality of vendor accounts, the vendor module to receive a plurality of offers from the plurality of vendors, each of the plurality of offers associated with respective offer settings;
a consumer module comprising a plurality of consumer accounts for a plurality of consumers, the consumer module to present one or more offers from a first vendor in the plurality of vendors to a consumer when the consumer selects the first vendor; and
an offer qualification engine to determine whether a deposit of funds received from the consumer qualifies consumer for an offer from the first vendor using the respective offer settings of the offer, the pre-paid transaction manager to credit a consumer account for the consumer with the deposit of funds and a bonus associated with the offer if the offer qualification engine determines that the deposit of funds received from the consumer qualifies the consumer for the offer from the first vendor.

20. The pre-paid transaction manager of claim 19, wherein the consumer module comprises:
an account activity sub-module to present past transactions associated with the consumer account to the consumer; and
a consumer budgeting sub-module to facilitate consumer budgeting of funds in the consumer account; and
wherein the vendor module comprises:
a vendor offer data sub-module to present offer data for the plurality of offers to the plurality of vendors; and
a market analytics sub-module to facilitate vendor selection and customization of offers based on prior offer data for the plurality of vendors.

21. The pre-paid transaction manager of claim 19, wherein the consumer module further comprises:
a consumer exchange sub-module to allow the plurality of consumers to exchange account balances with one another.

22. The pre-paid transaction manager of claim 19, further comprising:
consumer card usable at any of the plurality of vendors that have received a pre-payment of funds from the consumer.
